(19) United States
(12) Patent Application Publication
(10) Pub. No.: US 2021/0309230 A1
(43) Pub. Date: Oct. 7, 2021

(54) ROAD SURFACE STATE DETERMINATION METHOD AND ROAD SURFACE STATE DETERMINATION DEVICE

(71) Applicant: BRIDGESTONE CORPORATION, Tokyo (JP)

(72) Inventors: Keita ISHII, Tokyo (JP); Takeshi MASAGO, Tokyo (JP); Takato GOTO, Tokyo (JP)

(73) Assignee: BRIDGESTONE CORPORATION, Tokyo (JP)

(21) Appl. No.: 16/607,546

(22) PCT Filed: Apr. 26, 2018
(86) PCT No.: PCT/JP2018/017083

§ 371 Date: Oct. 23, 2019

(30) Foreign Application Priority Data
Jun. 16, 2017 (JP) 2017-119103

(51) Int. Cl. B60W 40/06; G06N 20/10; G01V 1/00; G01W 1/00

(52) U.S. Cl. CPC B60W 40/06; G06N 20/10; B60W 2422/70; G01W 1/00; G01V 1/001

(57) ABSTRACT

A method for determining a state of a road surface in which, a time-series waveform of tire vibration detected by an acceleration sensor is windowed by a windowing means with a time T and a feature vector Xᵢ in each time window is calculated through the extraction of a time-series waveform of the tire-vibration in each time window. Thereafter, in the calculation of a kernel function K_{A} from the feature vector Xᵢ in each time window and a road surface feature vector Y_{Aj} that is a feature vector in each time window calculated from a time-series waveform of tire-vibration that has been calculated in advance for each road surface state, the feature vector Xᵢ in each time window and the road-surface feature vector Y_{Aj} are made to be vibration levels of frequency bands of 500 Hz or greater extracted from the time-series waveform in each time window.

### TECHNICAL FIELD

The present invention relates to a method and a device for determining a state of a road surface on which a vehicle travels, and more specifically, relates to a method for determining the road surface using only data of a time-series waveform of vibration of a running tire.

### BACKGROUND

Conventionally, as a method for determining a state of a road surface by using only data of a time-series waveform of vibration of a running tire, there has been proposed a method in which a state of a road surface is determined by using a kernel function which is calculated from feature amounts in respective time windows calculated from time-series waveforms extracted by multiplying the time-series waveform of the tire vibration by a window function and from reference feature amounts which are feature amounts in the respective time windows obtained in advance for respective road surface states.

The reference feature amounts are obtained by machine learning (SVM) using, as learning data, the feature amount in each time window calculated from the time-series waveform of the tire vibration obtained in advance for each of road surface states (see Patent Document 1, for example).

### CITATION DOCUMENT

### Patent Document

Patent Document 1: Japanese Unexamined Patent Application Publication No. 2014-35279

### SUMMARY OF THE INVENTION

### Technical Problem

However, in the conventional method, because a time stretching/contraction requires a significant amount of calculations even for determining two road surfaces of DRY/WET, there have been problems that the calculation takes a long time and the processing becomes very heavy.

The present invention has been made in view of the conventional problems and aims at improving the calculation speed by reducing the amount of calculations while securing the precision in determination of two road surfaces of DRY/WET, by suitably selecting a feature amount to be used for calculation of the kernel function.

### Solution to Problem

The inventors have found, as a result of earnest examinations, that by detecting vibration of a tire generated at the time the tire collides with water on a road surface when the tire is running on the road surface, it is possible to determine whether the road surface is a WET road surface where a water curtain exists in a certain degree that causes generation of the tire vibration or a DRY road surface where the water curtain does not exist, and thus the inventors have reached the present invention.

FIG. 9 illustrates frequency spectra of the tire vibration generated when the water flow of 100[l/min] or 1000[l/min], indicated by a void arrow, collides with a tire 20 fixed in a drum 30, in which the horizontal axis represents frequency [Hz] and the vertical axis represents acceleration [RMS dB]. FIG. 9 shows results of a case in which an acceleration sensor attached to the inside of the tire is in a leading position or in a trailing position.

From FIG. 9, it is noted that, in regions of a high frequency of 500 Hz or greater, a difference between a vibration level at the time of collision with the water on the road surface and a background level (BG Noise) without collision with the water is large.

Accordingly, when determining the state of the road surface using a kernel function, it is possible to improve the calculation speed by reducing the amount of calculations while securing the precision in determination of two road surfaces of DRY/WET, if only vibration levels of the frequency band of 500 Hz or greater are used as feature amounts for determination of the road surface, among the feature amounts extracted from the time-series waveform of the tire vibration.

Namely, the present invention relates to a method for determining a state of a road surface being in contact with a running tire, the method including: a step (a) of detecting vibration of the running tire with the use of a vibration detecting means provided inside of the tire; a step (b) of taking out a time-series waveform of the detected tire vibration; a step (c) of extracting a time-series waveform for each time window by multiplying the time-series waveform of the tire vibration by a window function of a predetermined time width; a step (d) of calculating a feature amount from the time-series waveform in each time window; a step (e) of calculating a kernel function from the feature amount in each time window calculated in the step (d) and a reference feature amount selected from feature amounts in the respective time windows calculated from a time series waveform of tire vibration obtained in advance for each road surface state; and a step (f) of determining the state of the road surface based on a value of a discriminant function using the kernel function, in which the feature amount in each time window calculated in the step (d) and the reference feature amount are either one of, or a plurality of, or all of a vibration level of a frequency band of 500 Hz or greater extracted from the time-series waveform in each time window, a time-varying dispersion of the vibration level of the frequency band, and a Cepstrum coefficient of the time-series waveform; and in which the step (f) includes determining whether the state of the road surface is a WET state in which a water curtain that collides with the running tire exists on the road surface, or a DRY state in which the water curtain does not exist.

Further, the present invention also relates to a road surface state determination device for determining a state of a road surface being in contact with a running tire, the device including: a tire vibration detecting means that is disposed on an air chamber side of an inner liner portion of a tire tread portion and that detects vibration of the running tire; a windowing means that windows, with a previously set time width, a time-series waveform of the tire vibration detected by the tire vibration detecting means to extract a time-series waveform of the tire vibration for each time window; a feature amount calculating means that calculates a feature amount having, as a component thereof, a vibration level of a specific frequency in the extracted time-series waveform in each time window, or a feature amount having, as a component thereof, a function of the vibration level of the specific frequency; a storage means that stores a reference feature amount selected from feature amounts in respective time windows calculated from a time-series waveform of tire vibration that has been calculated in advance for each road surface state; a kernel function calculating means that calculates a kernel function from the feature amount in each time window calculated by the feature amount calculating means and the reference feature amount stored in the storage means; and a road surface state determining means that determines the state of the road surface based on a value of a discriminant function using the kernel function, in which the feature amount in each time window calculated by the feature amount calculating means and the reference feature amount stored in the storage means are either one of, or a plurality of, or all of a vibration level of a frequency band of 500 Hz or greater extracted from the time-series waveform in each time window, a time-varying dispersion of the vibration level of the frequency band and a Cepstrum coefficient of the time-series waveform; and in which the road surface state determining means determines whether the state of the road surface is a WET state in which a water curtain that collides with the running tire exists on the road surface, or a DRY state in which the water curtain does not exist.

The summary of the invention does not enumerate all the features required for the present invention, and sub-combinations of these features may also become the invention.

### BRIEF DESCRIPTION OF THE DRAWINGS

FIG. 1 is a functional block diagram illustrating a configuration of a road surface condition determination device according to an exemplary embodiment of the present invention;

FIG. 2 is a diagram illustrating an example of a mounting position of an acceleration sensor;

FIG. 3 is a diagram illustrating an example of a time-series waveform of tire vibration;

FIG. 4 is a diagram illustrating a method for calculating feature vectors from the time-series waveform of the tire vibration;

FIG. 5 is a diagram illustrating an input space;

FIG. 6 is a diagram illustrating a road surface feature vector of a DRY road surface and a road surface feature vector of a WET road surface in the input space;

FIG. 7 is a diagram illustrating a method for calculating a GA kernel;

FIG. 8 is a flowchart illustrating a method for determining a road surface state according to the exemplary embodiment of the present invention;

FIG. 9 is a diagram illustrating an example of frequency spectrum of the tire vibration generated when a water flow collides with the tire; and

FIG. 10 is a graph illustrating a relationship between a mounting position of the acceleration sensor and a determination precision.

### DESCRIPTION OF EMBODIMENT

Although the present invention is herein described in detail through an exemplary embodiment, however, the exemplary embodiment described below does not limit the inventions set forth in the claims, and not all of the combinations of the features described in the exemplary embodiment are necessarily required for the solving means of the invention.

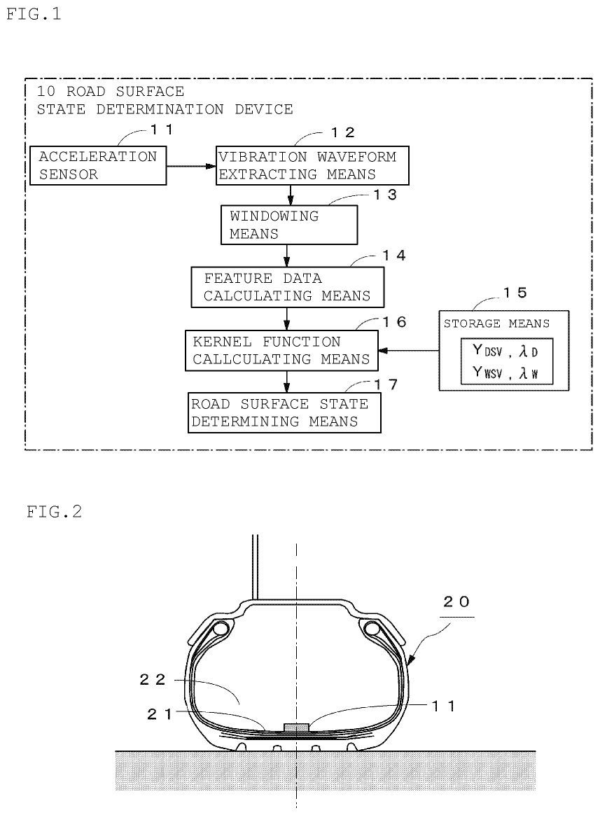

FIG. 1 is a functional block diagram illustrating a configuration of a road surface state determination device 10.

The road surface state determination device 10 includes an acceleration sensor 11 as a tire vibration detecting means, a vibration waveform extracting means 12, a windowing means 13, a feature vector calculating means 14, a storage means 15, a kernel function calculating means 16, and a road surface state determining means 17, and determines whether the road surface on which a tire is running is a Wet state in which a water curtain that collides with the running tire exists on the road surface, or a DRY state in which the water curtain does not exist.

The vibration waveform extracting means 12 to the road surface state determining means 17 are each configured, for example, by computer software and a memory such as a RAM.

The acceleration sensor 11 is, as illustrated in FIG. 2, disposed integrally with an inner liner portion 21 of the tire 20 in a substantially central portion on a tire air chamber 22 side, for detecting vibration of the tire 20 due to the input from the road surface. A signal of the tire vibration, which is an output of the acceleration sensor 11, is, for example, amplified by an amplifier, thereafter converted into a digital signal and sent to the vibration waveform extracting means 12.

The vibration waveform extracting means 12 extracts, for each one rotation of the tire, a time-series waveform of the tire vibration, from the signal of the tire vibration detected by the acceleration sensor 11.

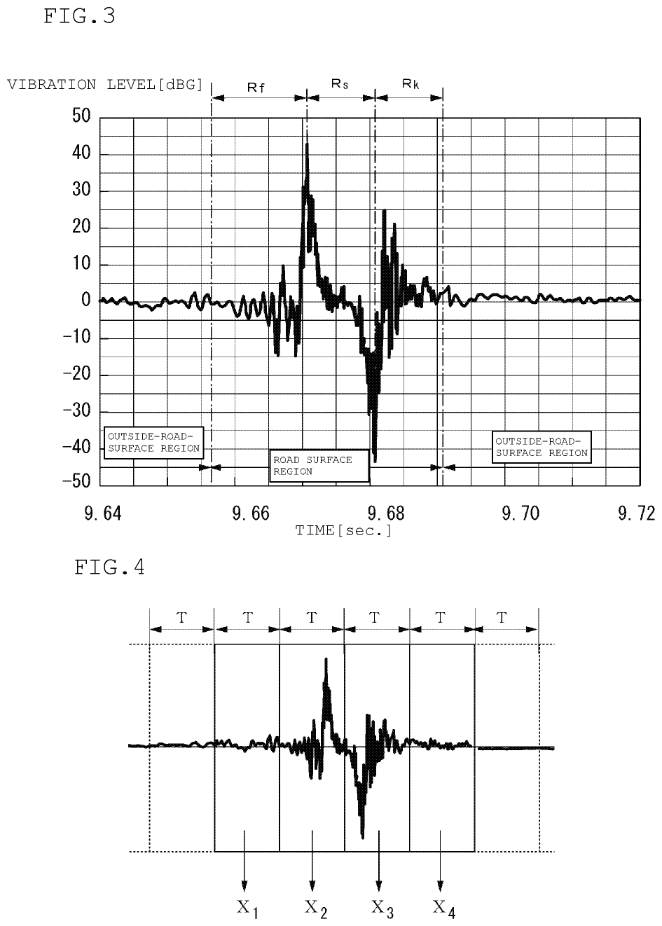

FIG. 3 is a diagram illustrating an example of the time-series waveform of the tire vibration. The time-series waveform of the tire vibration has large peaks in the vicinity of a step-in position and in the vicinity of a kick-out position, and in a pre-step-in region R_{f} that is a region before a land portion of the tire 20 contacts the ground, in a post-kick-out region Rₖ that is a region after the land portion of the tire 20 is left from the road surface and in a grounding region Rₛ that is a region where the land portion of the tire 20 is in contact with the ground, different vibrations appear depending on road surface states. On the other hand, because a region before the pre-step-in region R_{f} and a region after the post-kick-out region Rₖ (hereinafter referred to outside-road-surface regions) are not substantially affected by the influence of the road surface, vibration levels of these regions are low and information on the road surface is not included.

As illustrated in FIG. 3, in a case where a water curtain that collides with the running tire exists, vibration levels of the pre-step-in region R_{f} and the post-kick-out region Rₖ are high compared to a case where the water curtain does not exist. However, in the present exemplary embodiment, a time-series waveform of a road surface region (a region from the pre-step-in region R_{f} to the post-kick-out region Rₖ) is extracted from the time-series waveform of the tire vibration.

The windowing means 13, as illustrated in FIG. 4, windows the extracted time-series waveform by a previously set time width (also called as a time window width) T, extracts a time-series waveform of the tire vibration for each time window and sends the extracted time-series waveforms to the feature vector calculating means 14.

Incidentally, as described above, since the time-series waveforms of the outside-road-surface regions do not include the information on the road surface, in the present exemplary embodiment, only the time-series waveform of the road surface region is sent to the feature vector calculating means 14 so as to accelerate the speed of calculation of the kernel function.

Meantime, the outside-road-surface region may be defined in such a manner that, for example, a background level is set for the time-series waveform of the tire vibration, and a region having a vibration level lower than the background level is determined to be the outside-road-surface region.

The feature vector calculating means 14, as illustrated in FIG. 4, calculates a feature vector Xᵢ (i=1−N: N is the number of the extracted time-series waveforms in the time windows) for each of the extracted time-series waveforms in each time window.

In the present exemplary embodiment, as the feature vector Xᵢ to be calculated, vibration levels (power values of filter filtration waves) aᵢₖ (k=1-3) of specific frequency bands obtained by allowing the time-series waveform of the tire vibration to pass through respective band path filters of 2-3 kHz, 3-4 kHz and 4-5 kHz, were used.

The feature vector is Xᵢ=(aᵢ₁, aᵢ₂, aᵢ₃), and the number of the feature vectors Xᵢ is N.

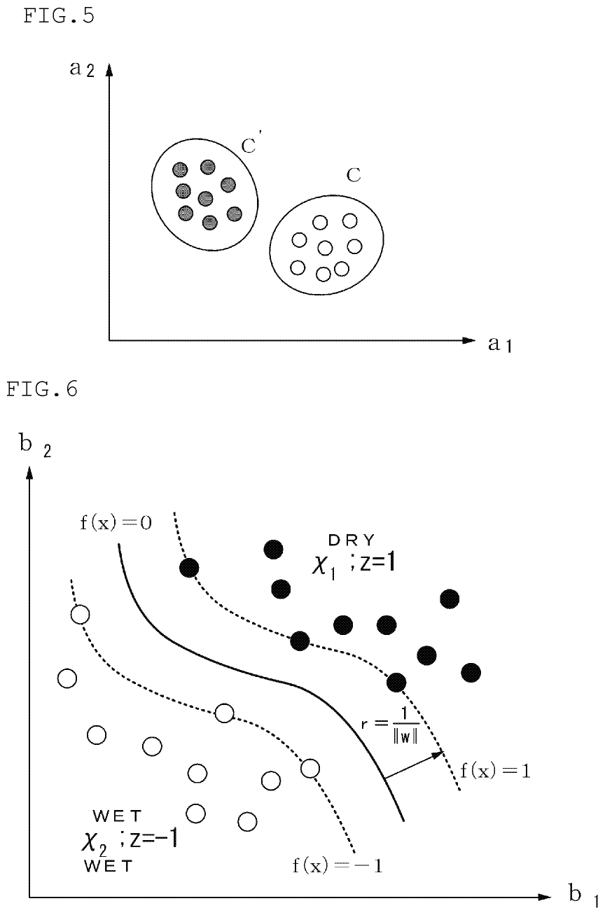

FIG. 5 is a diagram illustrating an input space of the feature vector Xᵢ, and each axis represents the vibration levels aᵢₖ of the specific frequency bands that are the feature amounts, and each dot represents the feature vector Xᵢ. An actual input space becomes a four-dimensional space, when a time axis is added, as the number of the specific frequency bands is three, however, FIG. 4 illustrates in two dimensions (the horizontal axis is a₁, the vertical axis is a₂).

In FIG. 5, let a group C be aggregation of the feature vectors Xᵢ when running on a DRY road surface and a group C′ be aggregation of feature vectors X′ᵢ when running on a WET road surface, and if the group C is distinguishable from the group C′, it is possible to determine whether the road surface on which the tire is running is the DRY road surface or the WET road surface.

Here, the “WET road surface” refers to a road surface where the water curtain that collides with the running tire exists and the “DRY road surface” refers to a road surface where the water curtain does not exist.

The storage means 15 stores reference feature vectors Y_{ASV} (yⱼₖ), which have been obtained in advance and which are reference feature amounts for separating the DRY road surface and the WET road surface by a discriminant function f (x) representing a separate hyperplane, and a Lagrange multiplier λ_{A} for weighting the reference feature vectors Y_{ASV}.

The reference feature amounts (Y_{ASV} (yⱼₖ) and λ_{A}) are obtained by learning using, as input data, road surface feature vectors Y_{A} (yⱼₖ), which are each a feature vector in each time windows, calculated from time-series waveforms of the tire vibration obtained by running, on the DRY road surface and the WET road surface at various speeds, a test vehicle loaded with a tire having the acceleration sensor attached thereto.

The tire size to be used in the learning may be one type or may be plural types.

The suffix A of the reference feature vector Y_{ASV} (yⱼₖ) represents DRY or WET.

The suffix j (j=1−M) represents a window number of the time-series waveform extracted for each time window, and the suffix k represents a vector component (k=1-3). Namely, yⱼₖ=(aⱼ₁, aⱼ₂, aⱼ₃). Further, SV is an abbreviation for the support vector.

Incidentally, in a case where the global alignment kernel function is used, as in the present exemplary embodiment, the reference feature vectors Y_{ASV} (yⱼₖ) become matrixes of the number of dimensions (here, 3×M (M: the number of windows) of the vector yᵢ.

Hereinafter, the road surface feature vector Y_{A} (yⱼₖ) and the reference feature vector Y_{ASV} (yⱼₖ) are expressed as Y_{A} and Y_{ASV}, respectively.

The method for calculating the road surface feature vector Y_{A} is such that, as similar to the above-described feature vector Xⱼ, for a reference feature vector Y_{D} of the DRY road surface, for example, the time-series waveform of the tire vibration when running on the DRY road surface is windowed by the time width T to extract a time-series waveform of the tire vibration for each time window, and the DRY road surface feature vector Y_{D} is calculated for each of the extracted time-series waveforms in each time window. Similarly, a WET road surface feature vector Y_{W} is calculated from each of the time-series waveforms in each time window when running on the WET road surface.

The reference feature vectors Y_{ASV} are feature vectors selected as support vectors by the support vector machine (SVM) using, as learning data, the DRY road surface feature vector Y_{D} and the WET road surface feature vector Y_{W}.

Incidentally, all of the reference feature vectors Y_{ASV} are not necessarily stored in the storage means 15, in general, it is sufficient to store only the support vectors Y_{ASV} whose Lagrange multiplier a has a predetermined value λₘᵢₙ (for example, λₘᵢₙ=0.05) or greater, as the reference feature vectors Y_{ASV}.

Here, it is vital that the time width T is the same value as the time width T for obtaining the feature vector Xj. When the time width T is constant, the number M of the time-series waveforms in the time windows differs depending a tire type and a vehicle speed. That is, the number M of the time-series waveforms in the time windows of the road surface feature vector Y_{A} do not necessarily coincide with the number N of the time-series waveforms in the time windows of the feature vector Xⱼ. For example, in a case where a vehicle speed when obtaining the feature vector Xⱼ is slower than a vehicle speed when obtaining the road surface feature vector Y_{A}, M>N holds, and when faster, M<N holds.

FIG. 6 is a conceptual diagram illustrating the DRY road surface feature vector Y_{D} and the WET road surface feature vector Y_{W} in the input space. In FIG. 6, the black dot represents the DRY road surface and the white dot represents the WET road surface.

As described above, the DRY road surface feature vector Y_{D} and the WET road surface feature vector Y_{W} are both matrixes, however, for explaining the manner of obtaining discrimination boundaries of groups, the DRY road surface feature vector Y_{D} and the WET road surface feature vector Y_{W} are shown in two-dimensional vectors, respectively.

Generally, linear separation of the discrimination boundaries of the groups is impossible. Therefore, the linear separation is performed, with the use of the kernel method, by mapping the road surface feature vectors Y_{D} and Y_{W} into a high-dimensional feature space by non-linear map φ, so as to perform non-linear classification for the road surface feature vectors Y_{D} and Y_{W} in the original input space.

To distinguish the DRY road surface from the WET road surface, a margin is given to a discriminant function f (x), which is the separation hyperplane that separates the DRY road surface feature vector Y_{D} from the WET road surface feature vector Y_{W}, whereby the DRY road surface and the WET road surface are precisely distinguished.

The margin refers to a distance to a sample that is nearest from the separation hyperplane, and the separation hyperplane, which is the discrimination boundary, is f (x)=0. Further, all the DRY load surface feature vectors Y_{Dj} exist in the region of f (x)=≥+1, and all the WET road surface feature vectors Y_{Wj} exist in the region of f (x)≤−1.

Next, by using aggregation of data X=(x₁, x₂, . . . xₙ) and belonging classes z={1, −1}, an optimum discriminant function f (x)=w^{T} φ(x)−b for discriminating data is obtained. Here, w is a vector representing a weighting factor and b is a constant.

The data are the DRY road surface feature vector Y_{Dj} and the WET road surface feature vector Y_{Wj}. As to the belonging class, z=1 represents data of the DRY road surface indicated by χ₁, and z=−1 represents data of the WET road surface indicated by χ₂ in FIG. 6. Further, f (x)=0 is the discrimination boundary and 1/∥w∥ is a distance between the road surface feature vector Y_{Aj} (A=D, W) and f (x)=0.

The discriminant function f (x)=w^{T} φ(x)−b is optimized, by using the Lagrange undetermined multiplier method, for example. The optimization problem is replaced with the following equations (1) and (2).

$$\begin{matrix}[ Math . 1 ] & \\ maximize {\sum }_{α} {λ}_{α} - \frac{1}{2} {\sum }_{α , β} {λ}_{α} {λ}_{β} {z}_{α} {z}_{β} {ϕ}^{⊤} ( {x}_{α} ) ϕ ( {x}_{β} ) & ( 1 ) \\ subject to {\sum }_{α} {λ}_{α} {z}_{α} = 0 , \\ {λ}_{α} > 0 & ( 2 )\end{matrix}$$

Here, α and β are indices of plural learning data. Also, λ is the Lagrange multiplier, and the road surface feature vector Y_{Aj} whose λ=0 is vector data that is not involved in (not the support data) the discriminant function f (x).

At this time, by replacing an inner product φ^{T}(x_{α})φ(x_{β}) with the kernel function K (x_{α}, x_{β}), the discriminant function f (x)=w^{T}φ(x)−b can be non-linearized.

The φ^{T}(x_{α})φ(x_{β}) is the inner product obtained after mapping the x_{α} and the x_{β} by the map p into a high-dimensional space.

The Lagrange multiplier λ can be obtained by using, in the equation (2), an optimization algorithm such as the steepest descent method, the sequential minimal optimization (SMO) and the like. In this manner, by replacing to the kernel function K (x_{α}, x_{β}) without directly obtaining the inner product φ^{T}(x_{α})φ(x_{β}), it becomes unnecessary to directly obtain an inner product of high dimensions. Accordingly, the calculation time can be reduced remarkably.

In the present exemplary embodiment, as the kernel function K (x_{α}, x_{β}), a global alignment kernel function (GA kernel) is used.

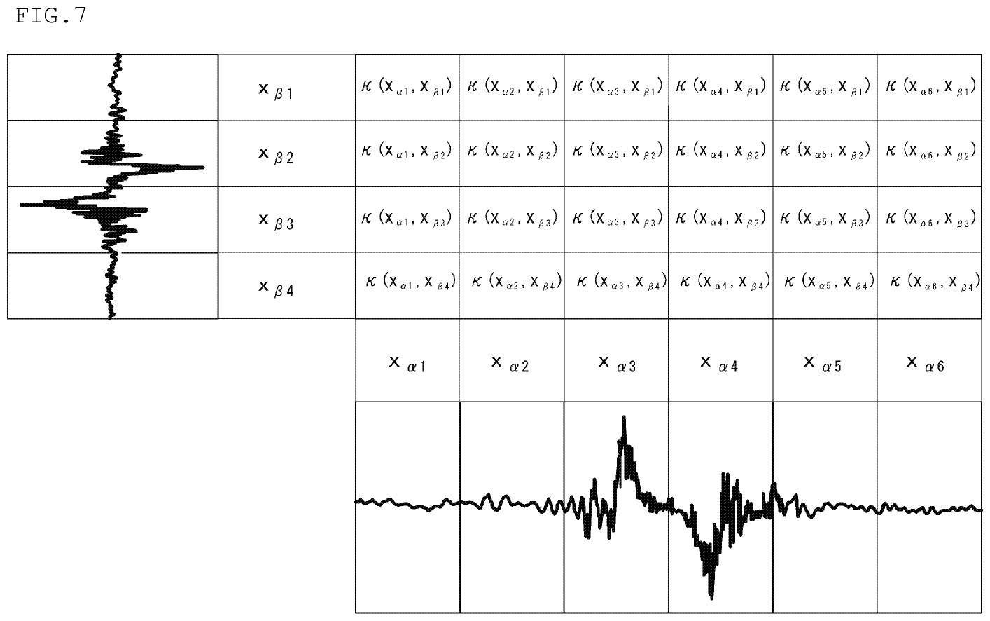

The GA kernel K (x_{α}, x_{β}) is, as shown in FIG. 7 and the following equations (3) and (4), a function formed of a total sum or a total product of local kernels κᵢⱼ (x_{αi}, X_{βj}) indicating a degree of similarity of the feature vector x_{α} and the feature vector x_{β}, which makes it possible to directly compare time-series waveforms having different time lengths. The local kernels κᵢⱼ (x_{αi}, x_{βj}) can be obtained for each time width T.

FIG. 7 illustrates an example of a case where the GA kernel is obtained from the feature vector x_{αi} whose number of windows is six (6) and the feature vector x_{βj} whose number of windows is four (4).

$$\begin{matrix}[ Math 2 ] & \\ K ( {x}_{α} , {x}_{β} ) = {\sum }_{i = 1}^{m} {\sum }_{j = 1}^{n} {κ}_{ij} ( {x}_{α i} , {x}_{β j} ) & ( 3 ) \\ {κ}_{ij} ( {x}_{α i} , {x}_{β j} ) = exp ( - \frac{{‖ {x}_{α i} - {x}_{β j} ‖}^{2}}{{σ}^{2}} ) & ( 4 )\end{matrix}$$

Here, ∥x_{αi}, x_{βj}∥ is a distance (norm) between the feature vectors and σ is a constant.

The kernel function calculating means 16 calculates DRY GA kernels K_{D} (X, Y_{DSV}) and WET GA kernels K_{W} (X, Y_{WSV}), from the feature vector Xᵢ calculated by the feature vector calculating means 14 and the reference feature vector Y_{DSV} of the DRY road surface and the reference feature vector Y_{WSV} of the WET road surface that are stored in the storage means 15.

The DRY GA kernel K_{D} (X, Y_{DSV}) is a function formed of a total sum or a total product of local kernels κᵢⱼ (Xᵢ, Y_{DSVj}), which are obtained when the feature vector x_{α} in the above equations (3) and (4) is replaced with the feature vector Xᵢ calculated by the feature vector calculation means 14 and the feature vector x_{β} in the above equations (3) and (4) is replaced with the reference feature vector Y_{DSVj} of the DRY road surface, and the WET GA kernel K_{W} (X, Y_{WSV}) is a function formed of a total sum or a total product of local kernels κᵢⱼ (Xᵢ, Y_{WSVj}) when the feature vector x_{β} is replaced with the reference feature vector Y_{WSVj} of the WET road surface. By using these GA kernels K_{D} (X, Y_{DSV}) and K_{W} (X, Y_{WSV}), time-series waveforms with different time lengths can directly be compared.

Incidentally, as described above, even in a case where the number n of the time-series waveforms in the time windows when obtaining the feature vector Xᵢ and the number m of the time-series waveforms in the time windows when obtaining the road surface feature vector Y_{Aj} are different, a degree of similarity between the feature vector Xᵢ and the reference feature vector Y_{ASVj} can be obtained.

The road surface determining means 17 determines the road surface state based on a value of the discriminant function f_{DW} (x) using the kernel function K_{D} (X, Y) and the kernel function K_{W} (X, Y) shown in the following equation (5).

$$\begin{matrix}[ Math 3 ] & \\ {f}_{DW} = {\sum }_{α = 1}^{{N}_{DSV}} {λ}_{D α} {z}_{D α} {K}_{D} ( X , {Y}_{{DSV}_{α}} ) - {b}_{D} + {\sum }_{α = 1}^{{N}_{WSV}} {λ}_{W α} {z}_{{W}_{α}} {K}_{W} ( X , {Y}_{{WSV}_{α}} ) - {b}_{W} & ( 5 )\end{matrix}$$

Here, N_{DSV} is the number of the reference feature vectors Y_{DSVj} of the DRY road surface and N_{WSV} is the number of the reference feature vectors Y_{WSVj} of the WET road surface.

In the present exemplary embodiment, the discriminant function f_{DW} is calculated and if f_{DW}>0, it is determined that the road surface is the DRY road surface, and if f_{DW}<0, it is determined that the road surface is the WET road surface.

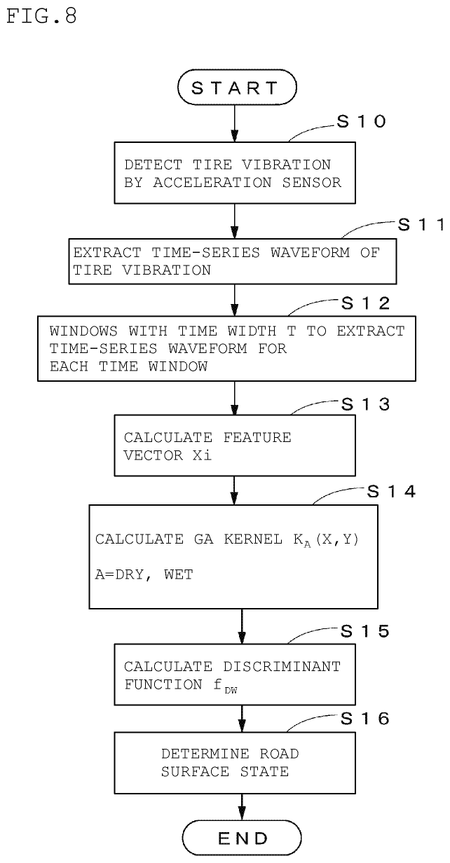

Next, an explanation is given, by referring to the flowchart of FIG. 8, on the method for determining a state of a road surface on which the tire 20 is running, with the use of the road surface state determining device 10.

First of all, a tire vibration, which is generated due to an input from a road surface R on which the tire 20 is running, is detected by the acceleration sensor 11 (Step 10), a time-series waveform of the tire vibration is extracted from a signal of the detected tire vibration (Step 11).

Then, the extracted time-series waveform of the tire vibration is windowed with a previously set time width T, and a time-series waveform of the tire vibration in each time window is obtained. Here, the number of the time-series waveforms of the tire vibration in the respective time windows is set to m (Step 12).

Next, the feature vectors Xᵢ=(xᵢ₁, xᵢ₂, xᵢ₃) are calculated for each of the extracted time-series waveforms in each time window (Step 13). In the present exemplary embodiment, the time width T is set to 3 msec. Further, the number of the feature vectors Xᵢ is six (6).

Each component xᵢ₁-xᵢ₃ (i=1-6) of the feature vector Xᵢ is, as described above, the power value of the filter filtration wave of the time-series waveform of the tire vibration.

Next, from the calculated feature vectors Xᵢ and the reference feature vectors Y_{ASVj} of the DRY road surface and the WET road surface stored in the storage means 15, the local kernels κᵢⱼ (Xᵢ, Y_{ASVj}) are calculated and thereafter a total sum of the local kernels κᵢⱼ (Xᵢ, Y_{ASV}) is obtained, and each of the GA kernel functions K_{A} (X, Y_{ASV}) is calculated (Step 14).

The kernel function K_{D} (X, Y_{DSV}) in which λ=D is the GA kernel function of the DRY road surface and the kernel function K_{W} (X, Y_{WSV}) in which A=W is the GA kernel function of the WET road surface.

Then, the discriminant function f_{D}W (x) using the GA kernel function K_{D} of the DRY road surface and the GA kernel function K_{W} of the WET road surface is calculated (Step 15), and if f_{DW}>0, it is determined that the road surface is the DRY road surface, and if f_{DW}<0, it is determined that the road surface is the WET road surface (Step 16).

In this manner, in the present exemplary embodiment, it is so arranged that the time-series waveform of the tire vibration detected by the acceleration sensor 11 is windowed by the windowing means 13, the time-series waveform of the tire vibration in each time window is extracted to calculate the feature vector Xᵢ. Thereafter, the kernel functions K_{A} (X, Y_{ASVj}) of the feature vector Xᵢ and the reference feature vector Y_{ASVj} of each road surface are obtained, and from a value of the discriminant function f_{DW} (X) using these kernel functions K_{A} (X, Y_{ASVj}), a road surface state of the road surface on which the tire 20 is running is determined. With this arrangement, the road surface state can be determined without detecting a peak position and without measuring a tire speed.

Furthermore, because the feature amount to be used for calculation of the kernel function is limited only to a high-frequency component, the amount of calculation can be reduced, and because a feature amount having a large difference between the DRY road surface and the WET road surface is used as the feature amount, the precision in determination of two road surfaces of DRY/WET can also be improved.

Table 1 is a table showing comparison between a data storage capacity when frequency bands of the feature vector Xᵢ and the road surface feature vector Y_{Aj}, which are the feature amounts, are high frequency bands (2-5 kHz) and a data storage capacity when the frequency bands are all of the frequency bands (0-5 kHz).

As apparent from the table, by setting the frequency bands of the feature amounts to be extracted to the high frequency band (2-5 kHz), data storage capacity was reduced to 44% of the data storage capacity when all of the frequency bands (0-5 kHz) are used.

TABLE 1

| | Data Storage | |
|---|---|---|
| Frequency Band | Capacity | Ratio |
| All Bands (0-5 kHz) | 14.7 MB | 100% |
| High Frequency (2-5 kHz) | 6.4 MB | 44% |

With this, it has been confirmed that when the feature amount to be used for calculation of the kernel function is limited only to a high-frequency component, the amount of calculation can be reduced, and also the precision in determination of two road surfaces of DRY/WET can be improved.

Furthermore, because determination of the road surface can be performed regardless of a ground contact length, a robustnesss can be improved.

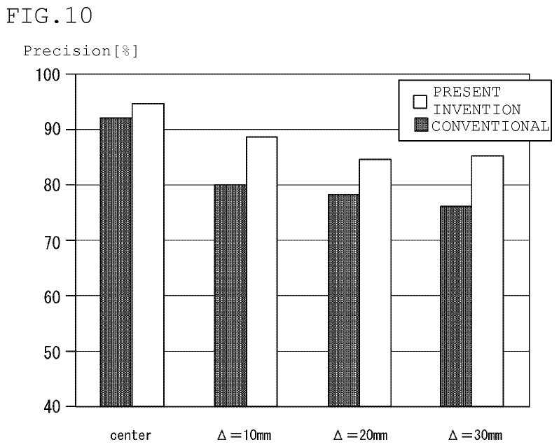

As a concrete example of robustnesss improvement, a result of search of degradation of precision in determination of two road surfaces of DRY/WET depending on the attachment position of the acceleration sensor 11 is shown by the graph in FIG. 10.

In the graph, the horizontal axis represents sensor positions and A is an amount (mm) of deviation from a tire width direction center (center), and the vertical axis represents a road surface determination precision (%).

As apparent from the graph, it is noticed that in the present invention, when the frequency band of the feature amount is in the high frequency band, degradation of the determination precision due to deviation of the sensor position can be more effectively controlled, compared to a case where the frequency band of the feature amount is in all the frequency bands (0-5 kHz).

In the present exemplary embodiment, the frequency bands of the feature vectors Xᵢ were 2-5 kHz and, the feature vectors Xᵢ to be calculated were set to vibration levels (the power value of the filter filtration wave) aᵢₖ (k=1-3) of the specific frequency bands obtained by allowing the time-series waveforms of the tire vibration to pass through respective band filters of 2-3 kHz, 3-4 kHz and 4-5 kHz. However, the frequency bands of the feature vectors Xᵢ to be extracted are not limited to these bands, the frequency bands for extracting the feature vectors Xᵢ may be changed such that, for example, the frequency bands are set to 0.5-5 kHz and the feature vectors Xᵢ are of the power values of five filter filtration waves of 0.5-1 kHz, 1-2 kHz, 2-3 kHz, 3-4 kHz and 4-5 kHz. In short, it is sufficient to set the frequency bands for extracting the feature vectors Xᵢ to 500 Hz or greater which is suitable for determining whether the road surface on which the tire is running is the DRY road surface or the WET road surface.

In the present exemplary embodiment, the tire vibration detecting means is the acceleration sensor 11, however, other vibration detecting means such as a pressure sensor may be used. Further, with respect to the mounting position of the acceleration sensor 11, one acceleration sensor 11 may be disposed at each of positions separated by a predetermined distance in the width direction from the center of the tire width direction, or may be disposed at other position such as inside of a block. Furthermore, the number of the acceleration sensor 11 is not limited to one, but may be disposed at plural positions in the tire circumferential direction.

In the present exemplary embodiment, the feature vector Xᵢ is set to the power value xᵢₖ of the filter filtration wave, however, time-varying variance (log [xᵢₖ(t)²+xᵢₖ(t−1)²] of the power value xᵢₖ of the filter filtration wave may be used. Or, the feature vector Xi may be a Fourier coefficient that is a vibration level of the specific frequency band when the time-series waveform of the tire vibration is subjected to Fourier conversion, or may be a Cepstrum coefficient. The Cepstrum coefficient can be obtained by assuming the Fourier-converted waveform to be the spectrum waveform and again Fourier converting the Fourier-converted waveform, or assuming an AR spectrum to be the waveform and further obtaining an AR coefficient (LPC Cepstrum). This enables to characterize the shape of the spectrum without being affected by the absolute level, and therefore, the determination precision is improved compared to a case where the frequency spectrum obtained by Fourier conversion is used.

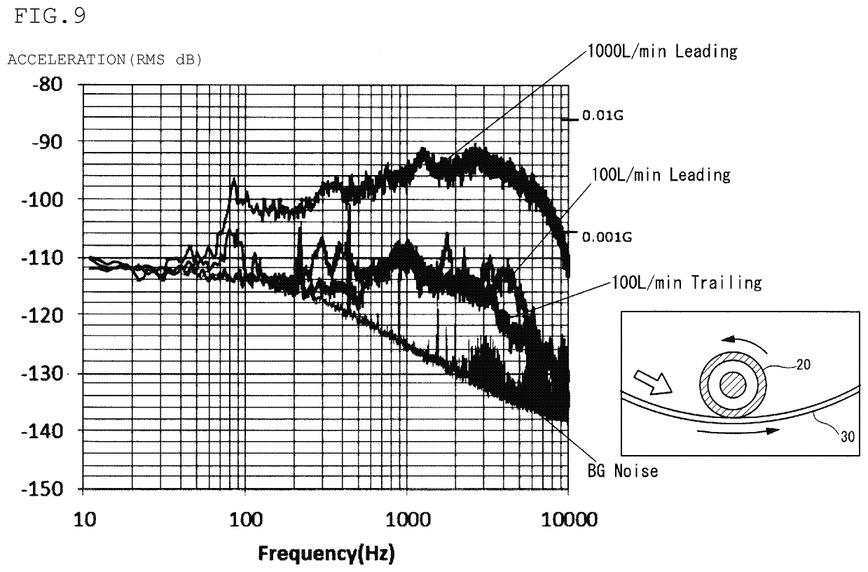

In the present exemplary embodiment, the feature vector Xᵢ is obtained by extracting the time-series waveform of the road surface region from the time-series waveform of the tire vibration, however, as illustrated in FIG. 9, because the influence to the vibration level due to the collision with the water curtain on the road surface is most significant in the pre-step-in region R_{f}, if the feature vector Xᵢ is obtained by multiplying the time-series waveform in the pre-step-in region R_{f} by the window function and by extracting the time-series waveform in each time window, the amount of calculation can further be reduced.

In the present exemplary embodiment, determination of two road surfaces of DRY/WET is performed, however, the present invention may be applied, not only to determination of the two road surfaces, but also to determination of four road surfaces of DRY/WET/ICE/SNOW and so on.

In the present exemplary embodiment, the GA kernel is used as the kernel function, however, a dynamic time warping kernel function (DTW kernel) may be used. Or, the GA kernel and a DTW kernel arithmetic value may be used.

Although the present invention has been described using the exemplary embodiment, the present invention can also be described as follows. That is, the present invention provides a method for determining a state of a road surface being in contact with a running tire, the method including: a step (a) of detecting vibration of the running tire with the use of a vibration detecting means provided inside of the tire; a step (b) of taking out a time-series waveform of the detected tire vibration; a step (c) of extracting a time-series waveform for each time window by multiplying the time-series waveform of the tire vibration by a window function of a predetermined time width; a step (d) of calculating a feature amount from the time-series waveform in each time window; a step (e) of calculating a kernel function from the feature amount in each time window calculated in the step (d) and a reference feature amount selected from feature amounts in the respective time windows calculated from a time series waveform of tire vibration obtained in advance for each road surface state; and a step (f) of determining the state of the road surface based on a value of a discriminant function using the kernel function, in which the feature amount in each time window calculated in the step (d) and the reference feature amount are either one of, or a plurality of, or all of a vibration level of a frequency band of 500 Hz or greater extracted from the time-series waveform in each time window, a time-varying dispersion of the vibration level of the frequency band, and a Cepstrum coefficient of the time-series waveform; and in which the step (f) includes determining whether the state of the road surface is a WET state in which a water curtain that collides with the running tire exists on the road surface, or a DRY state in which the water curtain does not exist.

More specifically, the “reference feature amount” is obtained by machine learning (SVM) using, as learning data, the feature amount in each time window calculated from the time-series waveform of tire vibration obtained in advance for each of road surface states.

In this way, as the feature amount used in calculation of the kernel function, since only a vibration level of a high-frequency component of 500 Hz or greater extracted from the time-series waveform in each time window is used, the amount of calculation can be reduced and the calculation speed can be improved. Further, since a feature amount having a large difference between the DRY road surface and the WET road surface is used as the feature amount, it is also possible to improve the precision in determination of two road surfaces of DRY/WET.

Furthermore, since as the kernel function, the global alignment kernel function, or the dynamic time warping kernel function, or the arithmetic value of the kernel function is used, the precision in determination of the road surface state was improved.

Further, because the windowing means windows the time-series waveform of the pre-step-in including the step-in point, in which the vibration level of the frequency band of 500 Hz or greater becomes higher in particular, to extract the time-series waveform in each time window, the amount of calculation was further improved while the precision in determination of two road surfaces of DRY/WET was sufficiently secured.

Further, the present invention provides a road surface state determination device for determining a state of a road surface being in contact with a running tire, the device including: a tire vibration detecting means that is disposed on an air chamber side of an inner liner portion of a tire tread portion and that detects vibration of the running tire; a windowing means that windows, with a previously set time width, a time-series waveform of the tire vibration detected by the tire vibration detecting means to extract a time-series waveform of the tire vibration for each time window; a feature amount calculating means that calculates a feature amount having, as a component thereof, a vibration level of a specific frequency in the extracted time-series waveform in each time window, or a feature amount having, as a component thereof, a function of the vibration level of the specific frequency; a storage means that stores a reference feature amount selected from feature amounts in respective time windows calculated from a time-series waveform of tire vibration that has been calculated in advance for each road surface state; a kernel function calculating means that calculates a kernel function from the feature amount in each time window calculated by the feature amount calculating means and the reference feature amount stored in the storage means; and a road surface state determining means that determines the state of the road surface based on a value of a discriminant function using the kernel function, in which the feature amount in each time window calculated by the feature amount calculating means and the reference feature amount stored in the storage means are either one of, or a plurality of, or all of a vibration level of a frequency band of 500 Hz or greater extracted from the time-series waveform in each time window, a time-varying dispersion of the vibration level of the frequency band and a Cepstrum coefficient of the time-series waveform; and in which the road surface state determining means determines whether the state of the road surface is a WET state in which a water curtain that collides with the running tire exists on the road surface, or a DRY state in which the water curtain does not exist.

With such a configuration mentioned above, it is possible to realize a road surface state determination device that is capable of reducing the amount of calculations and that is capable of determining two road surfaces of DRY/WET with a high precision.

### REFERENCE SIGN LIST

10: Road surface state determination device, 11: Acceleration sensor, 12: Vibration waveform detecting means, 13: Windowing means, 14: Feature vector calculating means, 15: Storage means, 16: Kernel function calculating means, 17: Road surface state determining means, 20: Tire, 21: Inner liner portion, and 22: Tire air chamber.

1. A method for determining a state of a road surface being in contact with a running tire, the method comprising:
a step (a) of detecting vibration of the running tire with the use of a vibration detecting means provided inside of the tire;
a step (b) of taking out a time-series waveform of the detected tire vibration;
a step (c) of extracting a time-series waveform for each time window by multiplying the time-series waveform of the tire vibration by a window function of a predetermined time width;
a step (d) of calculating a feature amount from the time-series waveform in each time window;
a step (e) of calculating a kernel function from the feature amount in each time window calculated in the step (d) and a reference feature amount selected from feature amounts in the respective time windows calculated from a time series waveform of tire vibration obtained in advance for each road surface state; and
a step (f) of determining the state of the road surface based on a value of a discriminant function using the kernel function,
wherein the feature amount in each time window calculated in the step (d) and the reference feature amount are either one of, or a plurality of, or all of a vibration level of a frequency band of 500 Hz or greater extracted from the time-series waveform in each time window, a time-varying dispersion of the vibration level of the frequency band, and a Cepstrum coefficient of the time-series waveform; and
wherein the step (f) includes determining whether the state of the road surface is a WET state in which a water curtain that collides with the running tire exists on the road surface, or a DRY state in which the water curtain does not exist.

2. The method according to claim 1, wherein the kernel function is either a global alignment kernel function, or a dynamic time warping kernel function, or an arithmetic value of the kernel function.

3. The method according to claim 1, wherein, the windowing means extracts the time-series waveform in each time window by multiplying a pre-step-in time-series waveform by a window function.

4. A road surface state determination device for determining a state of a road surface being in contact with a running tire, the device comprising:
a tire vibration detecting means that is disposed on an air chamber side of an inner liner portion of a tire tread portion and that detects vibration of the running tire;
a windowing means that windows, with a previously set time width, a time-series waveform of the tire vibration detected by the tire vibration detecting means to extract a time-series waveform of the tire vibration for each time window;
a feature amount calculating means that calculates a feature amount having, as a component thereof, a vibration level of a specific frequency in the extracted time-series waveform in each time window, or a feature amount having, as a component thereof, a function of the vibration level of the specific frequency;
a storage means that stores a reference feature amount selected from feature amounts in respective time windows calculated from a time-series waveform of tire vibration that has been calculated in advance for each road surface state;
a kernel function calculating means that calculates a kernel function from the feature amount in each time window calculated by the feature amount calculating means and the reference feature amount stored in the storage means; and
a road surface state determining means that determines the state of the road surface based on a value of a discriminant function using the kernel function,
wherein the feature amount in each time window calculated by the feature amount calculating means and the reference feature amount stored in the storage means are either one of, or a plurality of, or all of a vibration level of a frequency band of 500 Hz or greater extracted from the time-series waveform in each time window, a time-varying dispersion of the vibration level of the frequency band and a Cepstrum coefficient of the time-series waveform; and
wherein the road surface state determining means determines whether the state of the road surface is a WET state in which a water curtain that collides with the running tire exists on the road surface, or a DRY state in which the water curtain does not exist.
